(19) United States
(12) Patent Application Publication
(10) Pub. No.: US 2012/0136835 A1
(43) Pub. Date: May 31, 2012

(54) METHOD AND APPARATUS FOR REBALANCING DATA

(75) Inventors: Yekesa Kosuru, Westford, MA (US); John Cohen, Nahant, MA (US)

(73) Assignee: Nokia Corporation, Espoo (FI)

(21) Appl. No.: 12/956,917

(22) Filed: Nov. 30, 2010

(51) Int. Cl. G06F 17/30

(52) U.S. Cl. 707/654; 707/E17.005

(57) ABSTRACT

An approach is provided for rebalancing data. A backup of at least one database associated with a server is determined. A restoration of the backup to at least one other server is determined to be caused. Routing information to route queries for information stored in the at least one database is determined to be modified to the at least one other server as part of a rebalancing process.

### BACKGROUND

Service providers and device manufacturers (e.g., wireless, cellular, etc.) are continually challenged to deliver value and convenience to consumers by, for example, providing compelling network services. Important differentiators in the industry are application and network services as well as capabilities to support and scale these services. In particular, these applications and services can include accessing and managing data utilized, for example, by social services, media services, employment services, etc. These services may be implemented via one or more servers and/or clusters of servers. These servers and/or clusters may need to be maintained to redistribute load when a server requires to be serviced, needs to be replaced, is over loaded, or the like. However, technical challenges exist in quickly and efficiently rebalancing such servers and/or clusters while reducing any potential downtime to services utilizing the servers and/or clusters.

### SOME EXAMPLE EMBODIMENTS

Therefore, there is a need for an approach for rebalancing data.

According to one embodiment, a method comprises determining a backup of at least one database associated with a server. The method also comprises determining to cause, at least in part, actions for resulting in a restoration of the backup to at least one other server. The method further comprises determining to cause, at least in part, at least one modification of routing information to route queries for information stored in the at least one database to the at least one other server as part of a rebalancing process.

According to another embodiment, an apparatus comprises at least one processor, and at least one memory including computer program code, the at least one memory and the computer program code configured to, with the at least one processor, cause, at least in part, the apparatus to determine a backup of at least one database associated with a server. The apparatus is also caused to determine to cause, at least in part, actions for resulting in a restoration of the backup to at least one other server. The apparatus further causes at least one modification of routing information to route queries for information stored in the at least one database to the at least one other server as part of a rebalancing process.

According to another embodiment, a computer-readable storage medium carries one or more sequences of one or more instructions which, when executed by one or more processors, cause, at least in part, an apparatus to determine a backup of at least one database associated with a server. The apparatus is also caused to determine to cause, at least in part, actions for resulting in a restoration of the backup to at least one other server. The apparatus further causes at least one modification of routing information to route queries for information stored in the at least one database to the at least one other server as part of a rebalancing process.

According to another embodiment, an apparatus comprises means for determining a backup of at least one database associated with a server. The apparatus also comprises means for determining to cause, at least in part, actions for resulting in a restoration of the backup to at least one other server. The apparatus further comprises means for determining to cause, at least in part, at least one modification of routing information to route queries for information stored in the at least one database to the at least one other server as part of a rebalancing process.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing services via a backend capable of rebalancing data, according to one embodiment;

FIG. 2 is a diagram of the components of a distributed key value store, according to one embodiment;

FIG. 3 is a diagram of a system utilizing a rebalancing process, according to one embodiment;

FIG. 4 is a flowchart of a process for rebalancing data, according to one embodiment;

FIGS. 5-7 are diagrams of systems utilizing rebalancing processes, according to various embodiments;

FIG. 8 is a diagram of a user interface that can utilize the backend utilizing the processes of FIG. 4, according to one embodiment;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for rebalancing data are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

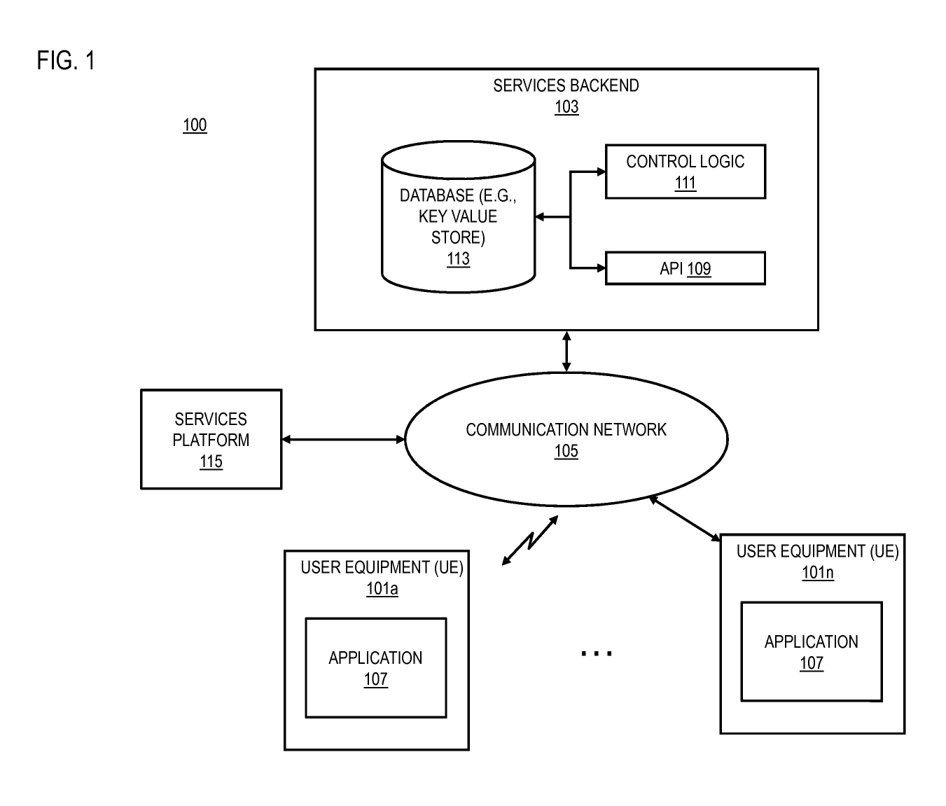

FIG. 1 is a diagram of a system capable of providing services via a backend capable of rebalancing data, according to one embodiment. With an increasing demand for network services (e.g., social networking services, media services, etc.), the need to properly manage access of data to users of the services is of paramount concern. An integral part of such services is providing correct data to users while allowing for scalability and redundancy. Consequently, larger databases have developed and use of the larger databases has increased. Large databases can be developed utilizing multiple nodes to allow for redundancy. Such redundancy can allow for failover of information to another node if one node fails. Further, large databases can include one or more smaller databases.

As such, databases can additionally be split into smaller databases (e.g., partitions or database shards) that can be failed over or otherwise be transferred to other nodes. This process can be utilized, for example, to rebalance loads on databases when. The databases can be queried by users of services. When a particular database is utilized to a certain threshold, the database system structure can be rebalanced over nodes to provide a more stable and/or more efficient system load for users of the service. However, such rebalancing may be time consuming and/or inefficient, thus causing network congestion and/or delay in users of the system receiving information being queried. For these purposes, users can include client systems, services, other devices utilizing the database, combinations thereof, etc.

To address these problems, a system 100 of FIG. 1 introduces the capability to rebalance data. User equipment (UEs) 101a-101n can request services from a services backend 103 via a communication network 105. An application 107 (e.g., a services application, a map application, a social networking application, etc) can request such services via an application programming interface (API) 109 of the services backend 103. Control logic 111 of the services backend 103 receives such requests and utilizes a database 113, such as a key value store, to provide services to the applications 107. In certain scenarios, the database 113 includes one or more servers, nodes, and/or clusters, associated with storage.

The database 113 can be structured utilizing one or more systems. As noted above, the database 113 can be a distributed key value store. In certain embodiments, a distributed key value store allows for the storage of values by key. The value itself can be a corpus or body of information that need not be structured. An index of keys can be generated to search for keys that may be useful to users. The key can then be retrieved and sent to a client system. Although various embodiments are described with respect to the key value store, it is contemplated that the approach described herein may be used with other databases (e.g., a distributed database under the control of a database management system, where the storage devices are not all attached to a common processor or a non-distributed database). Key based storage can additionally be useful for social services (e.g., where the key is tied to a user profile), user sessions, shopping carts (e.g., where the key is for a shopping selection for an account of the user), or the like. In some embodiments, the database 113 can include one or more shard and/or horizontal partitioning systems. In certain embodiments, horizontal partitioning is a database where rows of a database table are separated instead of separating by columns. Each partition/separation can constitute a shard. The shards can further be partitioned by one or more rows.

While providing services to client systems (e.g., UEs 101, services platforms 115, etc.), the control logic 111 can forward or otherwise perform queries on information of the database 113. In certain scenarios, the database 113 can include one or more databases (e.g., shards, partitions, etc.). As queries are performed, the one or more of the databases that makeup a subset of the database 113 can become overloaded or otherwise require rebalancing (e.g., based on the addition or subtraction of a server node).

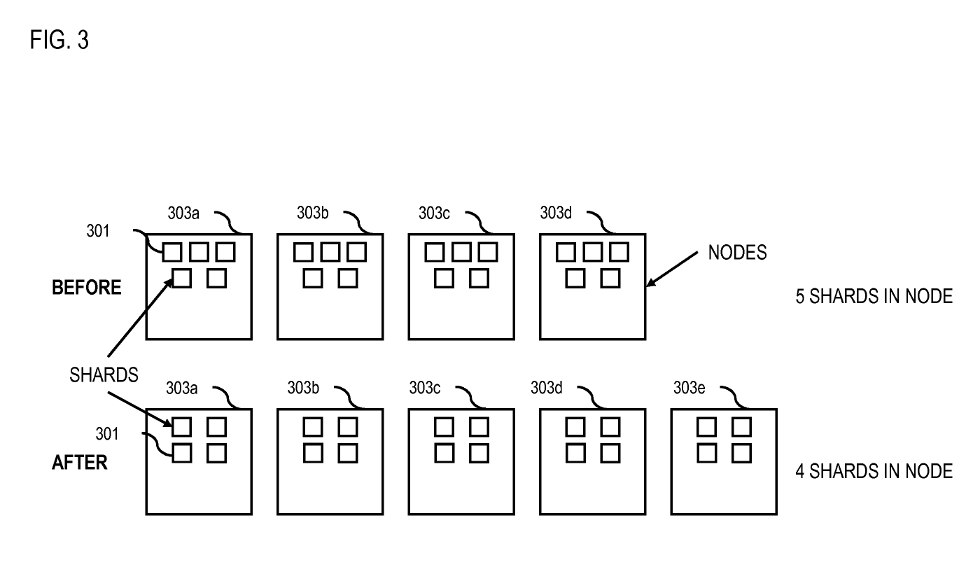

When a determination is made to rebalance the database 113, the control logic 111 can determine at least one or a part of the database (e.g., a subset of the database 113) to rebalance. Further detail as to the rebalancing process is provided in FIG. 3 and FIGS. 5-7. The control logic 111 can determine to backup the database(s) or the part of the database(s) that are to be rebalanced. Once this is determined, the control logic 111 can be utilized to generate the backup. In other scenarios, the backup is determined and created before a determination to rebalance. In these scenarios, the backup can be selected based on a determination that the associated database (on a first node) is to be rebalanced. The backup of the database or a part of the database may be generated via one or more backend processes. For example, a storage backend (e.g., a fibre optic storage backend, an Ethernet based backend, etc.) can be utilized for storing and backing up of the database. Further, the storage backend can be accessible via one or more other nodes. These nodes may access the backup via the storage backend and/or other communications methods (e.g., via an Ethernet connection to the node).

Then, the control logic 111 causes, at least in part, actions resulting in the restoration of the backup to at least one other node. This restoration process can include rebuilding or copying the database or a part of the database to another storage location via the storage backend. Once the restoration process is complete, queries that would be routed to the first node can be routed to the other node. This may be accomplished, for example, by modifying routing information utilized by the control logic 111 to route queries for information stored in the database to the other node.

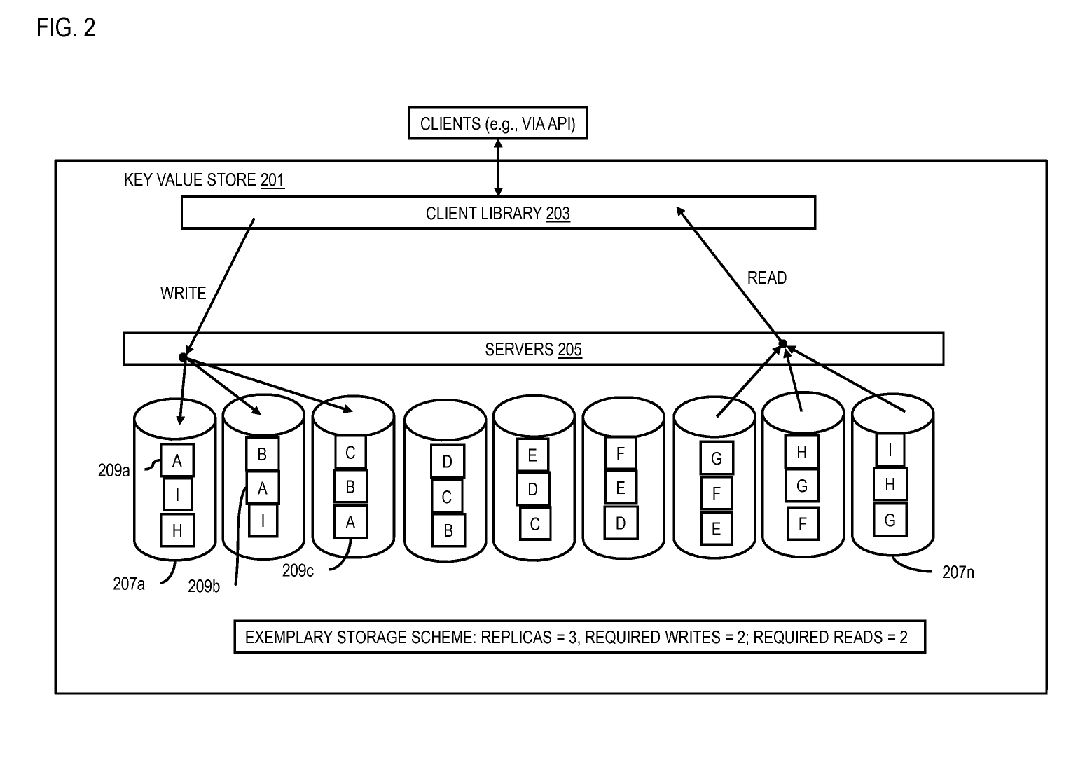

After the backup has been restored, the restored backup can further be compared to a current version (e.g., the most recent version) of the database. The comparison can be utilized to update the restored backup to the current version of the database. The update process can, for example, be a read-repair process. In certain scenarios, a read-repair process means that when a query is made against a given key, the query is performed against all replicas of the key and any replicas of the key that are out of date are pushed the most recent version. Further detail of the key store system is provided in the discussion of FIG. 2.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, services platform 115, and services backend 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

Further, communications between nodes utilized in the database 113 can be performed via one or more of the aforementioned protocols and/or technologies. Further, fast connections (e.g., gigabit Ethernet, fibre channel, etc.) can be utilized between nodes of a cluster, between nodes and backend storage, etc.

In one embodiment, the services backend 103 may interact according to a client-server model with the applications 107 of the UE(s) 101, services platform(s) 115, or the like. Further the services platform(s) 115 can provide services to applications 107 via the client-server model. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. A cluster of nodes 109 can perform the service 103. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

FIG. 2 is a diagram of the components of a key value store 201, according to one embodiment. By way of example, the key value store 201 includes one or more components for providing storage of data that can be indexed, stored, retrieved, and searched. In certain embodiments, the key value store 201 includes one or more profiles or other types of data stored utilizing keys. Further, the key value store 201 can be distributed (e.g., stored using one or more nodes in one or more locations). Moreover, a profile may be stored in the key value store 201. It is contemplated that the functions of these components may be combined in one or more components or performed by other components of equivalent functionality. It is further contemplated that other forms of databases may be utilized in place of or in addition to the key value store 201. In this embodiment, the key value store 201 includes a client library 203 that may be used to communicate with servers 205, and databases 207a-207n.

The control logic 111 and/or API 109 may communicate with the key value store 201 using a client library 203. In certain embodiments, the control logic 111, API 109, services platform 115, or applications 107 on UEs 101 may be considered clients receiving database services from the key value store 201. The client library 203 may include an interface that can determine which servers 205 to communicate with to retrieve content from databases 207. In certain embodiments, databases 207 are stored utilizing a key and value mechanism that allows storage using the key. A portion (e.g., a partition, a shard, etc.) of each database (e.g., portions A-I) can be linked to a key. In one embodiment, the key is hashed to determine which portion the key is linked to. A key may be hashed using a ring method, for example. Using the ring, each key and portion may be hashed to a primary location (e.g., based on a key with an identifier that is hashed into a number k) as well as one or more backup locations. The backup locations may be locations associated with the next server or host associated with the hash. The client library 203 determines which servers 205 to read and write information from and to using the key hashes. The client library 203 and the servers 205 may each include a lookup table including which portions belong which servers 205.

In certain embodiments, the portion (e.g., portion A 209a-209c) may be stored using multiple servers over multiple databases 207. In one implementation, portions may be replicated over n number (e.g., replicas=3) of servers 205 and databases 207 for redundancy, failover, and to reduce latency. Moreover, the portions may be written to and read from at the same time by the client library 203. When reading from the databases 207, the client library 203 may determine if there are any consistency issues (e.g., portion 209a does not match portion 209b). Moreover, in certain embodiments, an example storage scheme may require that when performing a write or a read, at least a certain number (e.g., required writes=2, required reads=2 etc.) of portions need to be successfully written or read. This allows for redundancy and quorum consistency. If a database 207a fails or is otherwise incapacitated, a portion 209a associated with the database 207a may be later updated with content it should include by servers 205 having replicated portions 209b, 209c.

The API 109 may request that a new profile (or other key based data structure) may be stored in the key value store 201. The new profile may be assigned a key based on an account identifier associated with the new profile. Then, the key may be hashed to determine a portion (e.g., portion A 209) to store the new profile in. Next, the profile is stored in a primary database as well as in backup databases. The profile may be considered a value associated with the key. To retrieve the profile at a later time, the hash of the key may be used to request the profile from the server associated with the portion. Then, the key may be utilized to search the portion for the profile.

The key value store 201 is an example of a particular database structure that can be utilized in rebalancing loads. Other types of database structures, for example, other key value stores, other databases, other shard databases, other partition based databases, etc. can be utilized in the rebalancing processes. While rebalancing shards, the load of the master shard and/or replica shards can be transferred. Routing information can be changed based on the status (e.g., master or replica) of the old and/or new node.

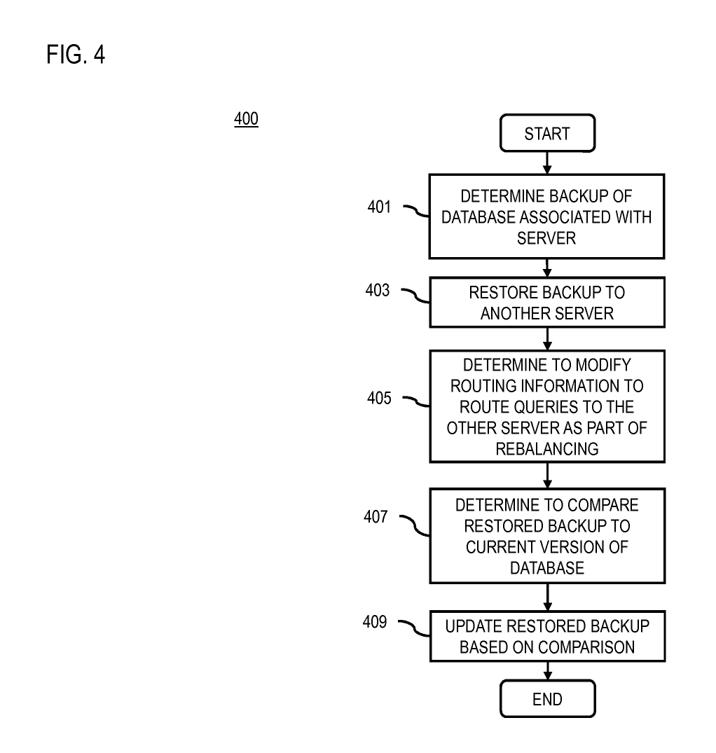

FIG. 3 is a diagram of a system utilizing a rebalancing process, according to one embodiment. In this embodiment, shards are utilized as example partitions or portions of databases, however, as noted above, other database structures are considered. Further, shards and/or partitions can be considered databases (e.g., a database that is a subset of a larger database). In this scenario, shards are originally provided utilizing four nodes 303a-303d. Each node 303a-303d, in this example has five shards 301. A rebalancing process is then triggered (e.g., based on the introduction of a new node 303e, based on a trigger in a load capacity of one of the nodes 303, etc.). Rebalancing then occurs to transfer one or more shards 301 to the additional node 303e. The rebalancing process, as further detailed in FIG. 4, can utilize a backup and restore mechanism to quickly and efficiently build the shards for the additional node 303e. In this manner, the shard databases or a portion thereof can be restored to the additional node 303e can be completed while the other nodes 303a-303d are active and allowing access to information in the shards 301, including shards that are to be transferred to node 303e. In this manner, the databases of node 303e can be built while the node 303e is offline.

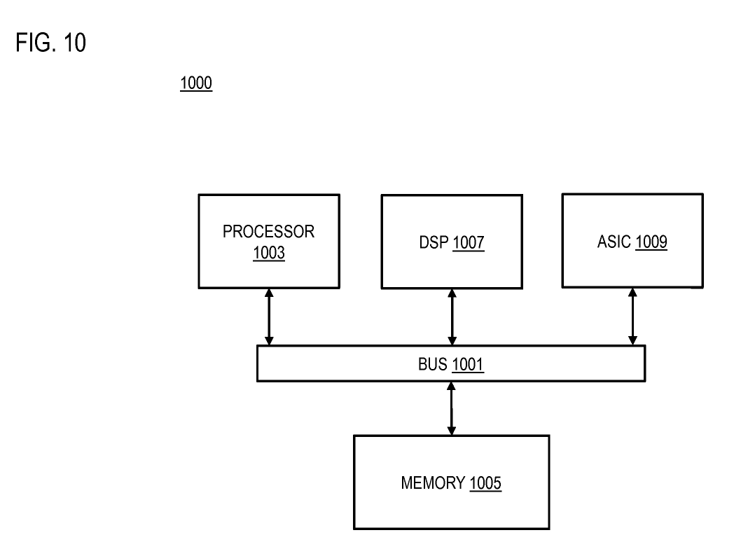

FIG. 4 is a flowchart of a process for rebalancing data, according to one embodiment. In one embodiment, the control logic 111 of a services backend 103 performs the process 400 and is implemented in, for instance, a chip set including a processor and a memory as shown in FIG. 10. Additionally or alternatively, one or more portions of the process 400 can be implemented via another device (e.g., one or more other nodes of a cluster, a head node or management node in charge of rebalancing, etc.). The control logic 111 and/or other devices can be utilized as means for implementing one or more steps of the process 400.

Control logic 111 can be utilized to determine to rebalance distribution of at least one database (e.g., a shard or portion in a larger database). The determination to rebalance can be based on an input from a user (e.g., an administrator). This may occur, for example, if an administrator determines to add or remove a node (e.g., a server) to a distribution of data. Further, a trigger for the determination can be set via a node monitoring the data. For example, a load threshold can be set for particular nodes and/or particular shards. When the threshold is crossed, rebalancing can be triggered. As such, a database meeting the load threshold can be considered “hot,” for example, being under a heavy load. Further, one or more shards can be backed up on a regular interval, based on triggers or events, or according to criteria. For example, a backup of a shard can be triggered based on the determination to rebalance the shard or based on unrelated backup purposes (e.g., for redundancy). The backup can be via a backend storage infrastructure (e.g., utilizing a storage backplane, one or more disk arrays, one or more enclosures, etc.).

In step 401, the control logic 111 determines a backup of at least one database associated with a node (e.g., a server). The backup can be of a shard that has been selected for rebalancing. This process can include either backing up the shard or by simply selecting a backup of the shard.

Then, at step 403, the control logic 111 determines to cause, at least in part, actions resulting in a restoration of the backup to at least one other node (e.g., server, cluster, etc.). The restoration process can be via a storage backplane. As such, the backup, restoration, or a combination thereof is performed via a first path (e.g., associated with the storage backplane). Further, queries for information in the database(s) can be performed via a second path. The second path can include, for example, an Ethernet connection or other network connection utilized to provide access to the at least one database to clients (e.g., applications 107, services platforms 115, etc.), for example, via an API 109. Moreover, in certain embodiments, a controller card utilized in one or more nodes can be utilized to process backup and/or restoration functionality. In one scenario, the control logic 111 (e.g., located on a management and/or rebalancing platform of the services backend 103) can cause restoration of the backup by sending a signal to the other node. The other node can then restore the backup (e.g., a shard).

As previously noted, in certain embodiments, the other node can be a node that is being provisioned. For example, the node can be initiated to be responsible for the shard and/or other shards. As such, the rebalancing process may include an initiation step of setting up the provisioned node. In other embodiments, the node originally associated with the database(s) can be decommissioned after the rebalancing process is completed. This may be done, for example, to upgrade server hardware.

Once the backup is restored on the other node, the control logic 111 can determine to modify routing information to route queries for information stored in the at least one database(s) to the other node as part of the rebalancing process (step 405). The modification can include transferring the routing of queries based on, for example, keys, to the other node. This can be accomplished by modifying routing tables and/or indexes associated with looking up information associated with the database. In certain embodiments, the modification of the routing information can be based, at least in part, on a determination that the restored backup is up-to-date.

At step 407, the control logic 111 determines to compare the restored backup to a current version of the database(s). The databases can be compared in portions, by keys, etc. Based, for example, on the comparison, if the restored backup is not up-to-date on a portion or key, the portion or key can be updated to the current version (step 409).

In certain embodiments, this can be performed on a shard by shard level or a key level. For example, a read-repair process can be utilized to update keys. In a read-repair process, each of the keys in the original database(s) can be queried. The query can be against all replicas of the keys and the most recent version of the data stored based on the key can be utilized to update out-of-date replicas. In one example, the other node can query the original database node for keys (e.g., one by one, in parallel, sequentially, etc.). As the keys are being queried, a version number or timestamp associated with the last update of the restored backup can be compared with a version number or timestamp of the original database and/or another replica or master database portion. If there is a discrepancy between the queried version and the backup version, the backup version is updated. Additionally or alternatively, the backup version is more recent (e.g., based on timestamp information), the backup version can remain. In certain scenarios, the update of the routing information can occur based on a shard level, a key level, etc. For example, on a key level, the routing information associate with a particular key can be updated to the node associated with the restored backup after the key has been queried (e.g., verified to be current). As such, the database(s) (e.g., shard(s)) can include one or more keys that are updated based on the verification process.

In one embodiment, shards can be divided into multiple shards and then backed up. In this manner, shards and/or databases can be split before being maintained by other nodes. For example, if a particular shard is overloaded (e.g., to the point where a node is unable to effectively process queries for information from the shard), the shard can be split. When split, portions can be separately backed up. One or more nodes can then restore the split shard(s) according to process 400. As such, data contained in the shard(s) can be rebalanced to one or more nodes utilizing process 400.

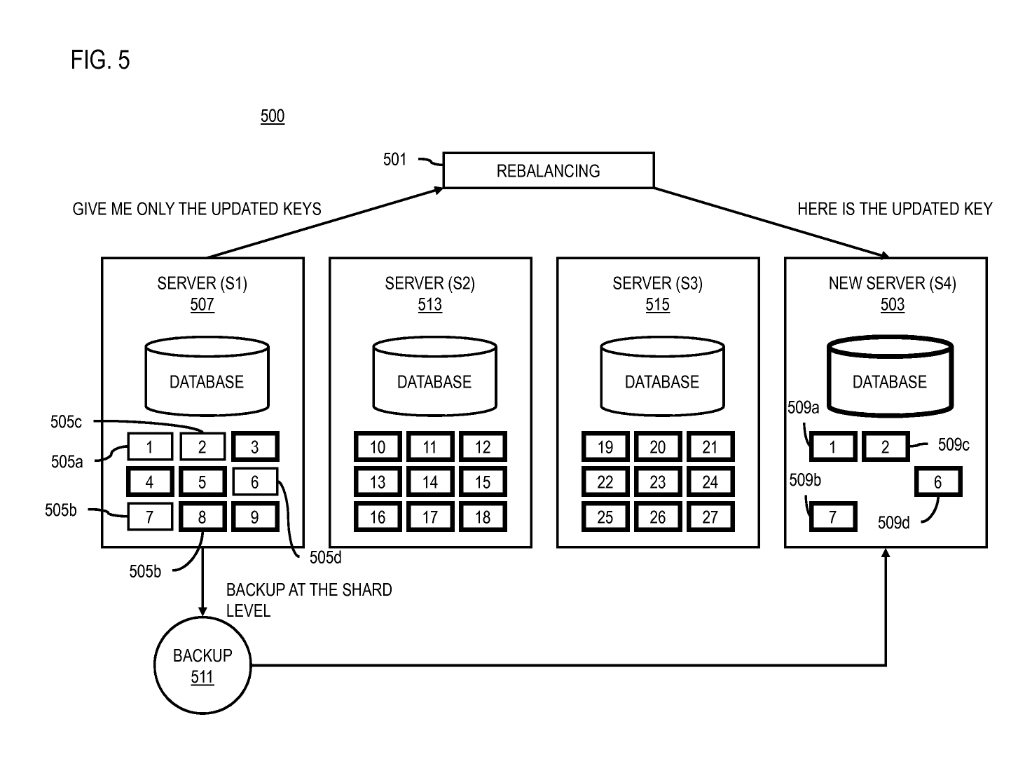

FIG. 5 is a diagram of a system utilizing rebalancing processes, according to one embodiment. The system 500 shows the rebalancing process graphically for the addition of a new server 503 and the moving of shards 505a-505d from a first server 507 to the new server 503. As such, at the end of process 400, shards 509a-509d can be active at the new server 503. Further, as shown in system 500, the first server 507 can include other active shards (outlined in bold) that are not transferred to the new server 503. To implement the rebalancing process, as described above, the shards can be backed up utilizing a storage backplane backup 511. The storage backplane backup 511 can be connected to the new server 503 and/or other servers 513, 515. As such, the shards 509a-509d can be restored to storage at the new server 503. The storage can be associated with a fast backend path (e.g., a fibre channel backplane). As such, the backup can quickly be restored to the new server 503 without going through lengthy transfers via other channels, such as a network interface. As noted previously, the new server 503 can request updated keys from the first server 507 that were updated after the backup 511 and/or new. These keys can be utilized to update the keys in the shards 509a-509d at the new server 503. Further, queries for information in the shards 509a-509d can be transferred (e.g., via a modification to routing information) to the new server 503 from the old server 507. Control logic 111 can act as a rebalancing agent (e.g., a cluster or server that may be utilized to manage rebalancing).

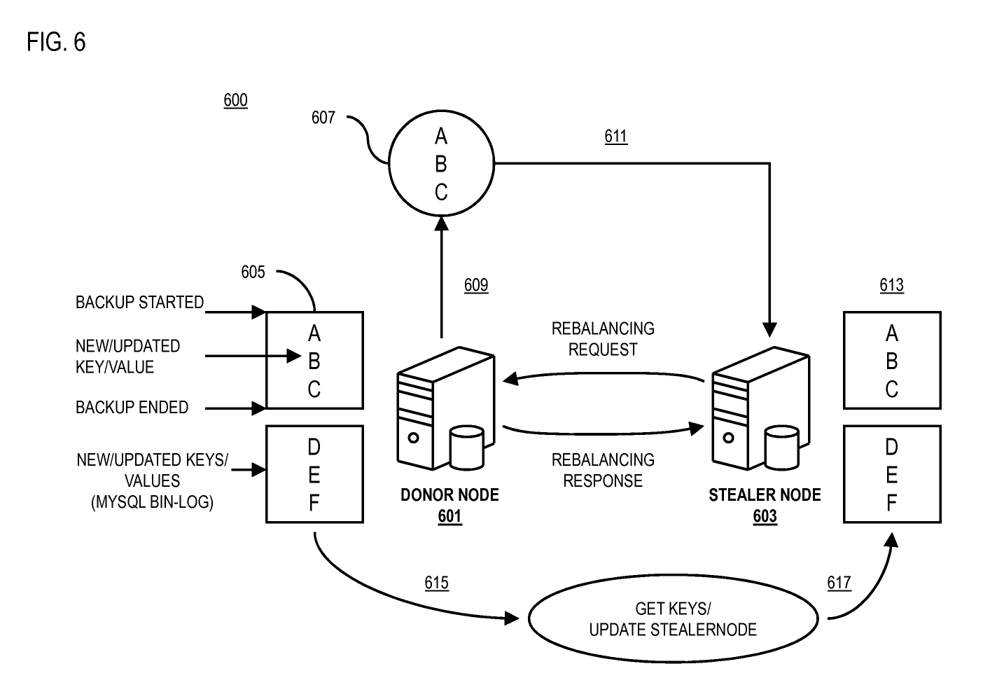

FIG. 6 is a diagram of a system utilizing rebalancing processes, according to one embodiment. In this system 600, a donor node 601 transfers one or more shards to a stealer node 603 during a rebalancing process. The donor node 601 can cause backup of one or more shards 605 of key-values to a backup storage 607 (step 609). The stealer node 603 then, at step 611 restores the shards 605 to storage 613 associated with the stealer node 603. As previously noted, this can occur in response to a rebalancing request and/or response. Once the backup is restored to storage 613, keys stored in the storage 613 can be updated by querying the donor node 601. As such, updated key/values and/or new key/values can be sent to (step 615) and received by (step 617) the stealer node 603. As previously detailed, the updating can be based on a read-repair process. Further, a log can be utilized to update the keys based on a determination of whether the keys were updated/added after backup.

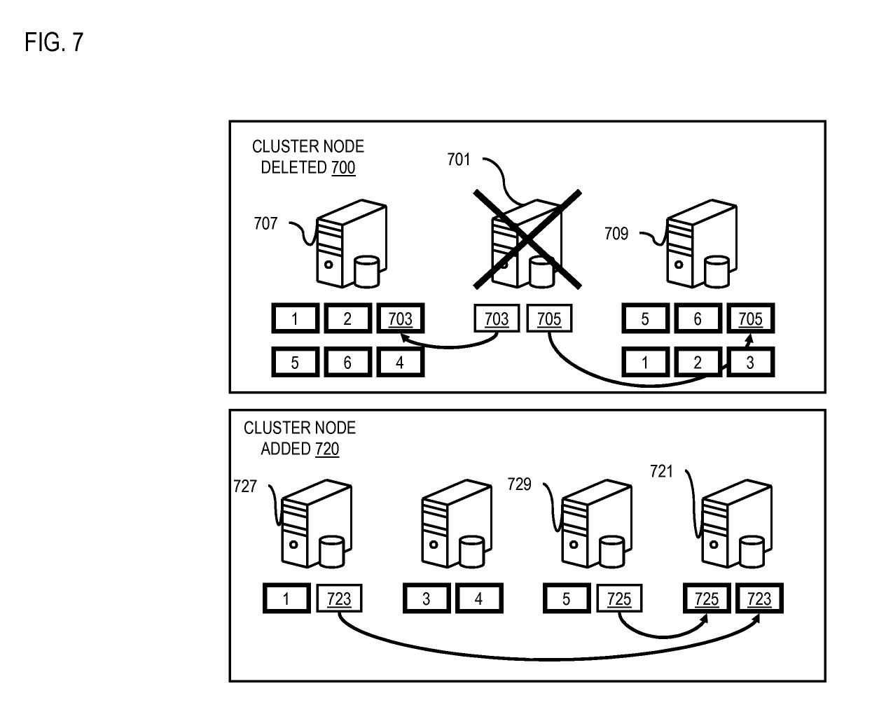

FIG. 7 is a diagram of systems utilizing rebalancing processes, according to various embodiments. System 700 shows an example of decommissioning a node 701 and rebalancing a system to accommodate shards maintained by the node 701. In this scenario, shards 703 and 705 are transferred to nodes 707 and 709. The shards 703, 705 can be transferred utilizing, for example, the steps of process 400. Once the shards 703, 705 are transferred and queries rerouted to nodes 707, 709, the node 701 can be removed from the system 700 (e.g., cluster).

System 720 shows an example of provisioning a node 721 and rebalancing a system to transfer shards 723, 725 to the new node 721. In this scenario, shards 723 and 725 are transferred from nodes 727 and 729. The shards 723, 725 can be transferred utilizing, for example, the steps of process 400. Queries can be rerouted to the new node 721 once the backup/restore process and any updating processes are completed by the new node 721.

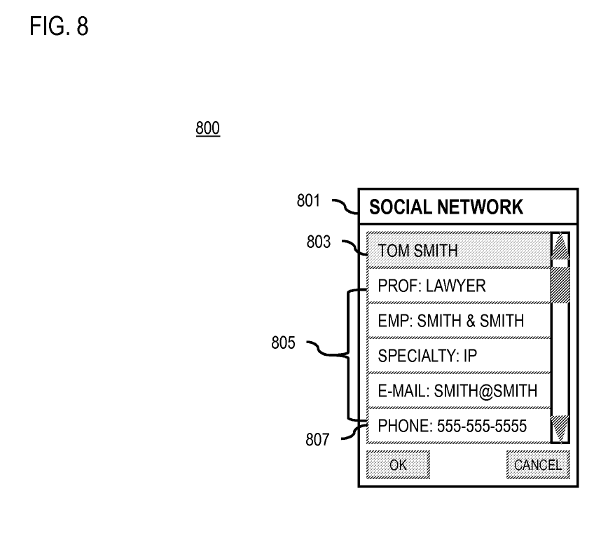

FIG. 8 is a diagram of a user interface that can utilize the backend utilizing the processes of FIG. 4, according to one embodiment. User interface 801 shows a presentation of a profile 803 of Tom Smith. The profile 803 can be stored in a key-value store and may be maintained and rebalanced utilizing the processes 400 of FIG. 4. The profile 803 may include information 805 associated with Tom Smith such as contact information 807. As previously noted, if one or more pieces of information 805 are changed during the backup/restore process, the restored backup can be updated with information from an updated/current database. As such, the information can be up-to-date before routing is changed to a new node/server associated with a new shard location.

With the above approaches, rebalancing of data can be accomplished quickly. For example, utilizing the backup/restore processes to allow nodes to transfer control of shards provides for quick initiation of new nodes and/or quick transfer of shards to other nodes. Initiation of the new nodes and/or new shards on active nodes can occur while the shards used are offline at the new node. In this manner, new nodes can be brought into use after being updated. Further, routing information associated with utilization of transferred shards or databases can be transferred dynamically when verification of the currency of the restored shards on the new node is completed. As such, portions of the shards can be utilized while other portions are being verified. Moreover, the system is available to provide answers to query requests during the rebalancing process.

The processes described herein for rebalancing data may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

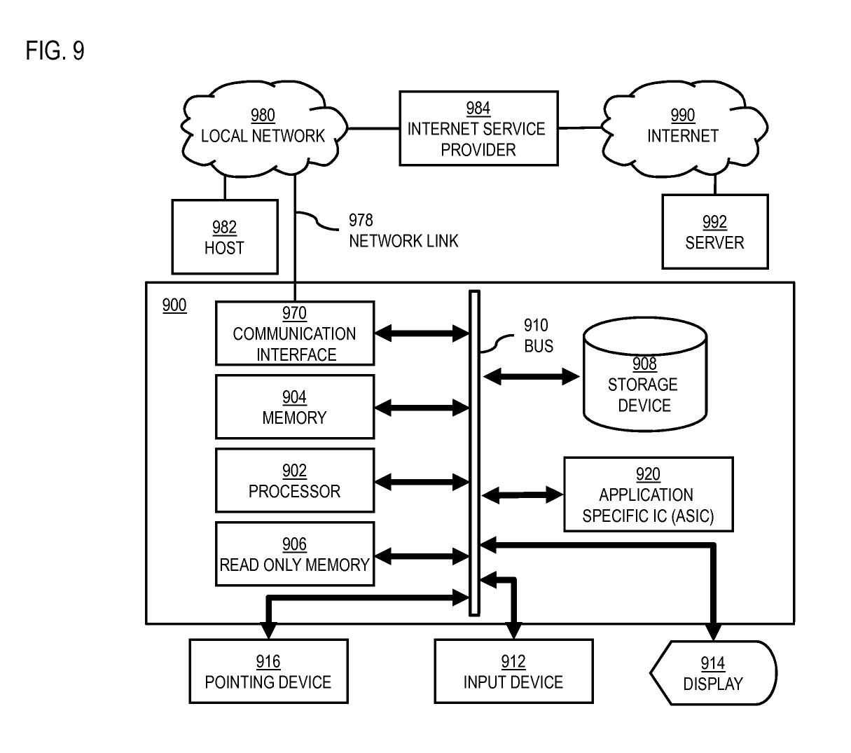

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to rebalance data as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of rebalancing data.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to rebalancing data. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or any other dynamic storage device, stores information including processor instructions for rebalancing data. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for rebalancing data, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT), a liquid crystal display (LCD), a light emitting diode (LED) display, an organic LED (OLED) display, a plasma screen, or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of ASICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 105 for the UE 101.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or any other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which an embodiment of the invention may be implemented. Chip set 1000 is programmed to rebalance data as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps of rebalancing data.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to rebalance data. The memory 1005 also stores the data associated with or generated by the execution of the inventive steps.

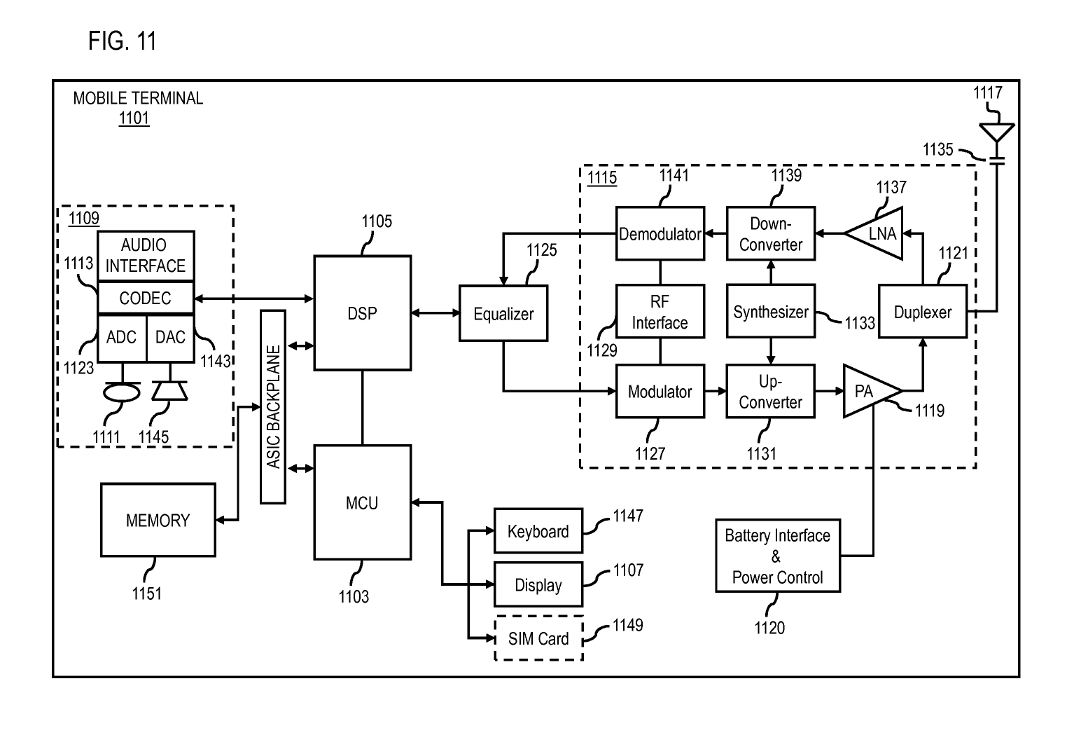

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of utilizing data stored on services backend 103. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of utilizing data stored on services backend 103. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to utilize data stored on services backend 103. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
a backup of at least one database or a part of the at least one database associated with a server;
at least one determination to cause, at least in part, actions for resulting in a restoration of the backup to at least one other server; and
at least one determination to cause, at least in part, at least one modification of routing information to route queries for information stored in the at least one database to the at least one other server as part of a rebalancing process.

2. A method of claim 1, wherein the (1) data and/or (2) information and/or (3) at least one signal are further based, at least in part, on the following:
at least one determination to compare the restored backup to a current version of the at least one database; and
at least one determination to update the restored backup based, at least in part, on the comparison.

3. A method of claim 2, wherein the update is based, at least in part, on a read-repair process.

4. A method of claim 1, wherein the backup, the restoration, or a combination thereof is performed over a first path and the queries are performed over a second path.

5. A method of claim 1, wherein the rebalancing process includes provisioning the at least one other server, decommissioning the server, or a combination thereof.

6. A method of claim 1, wherein the at least one database includes at least one shard.

7. A method of claim 6, wherein the at least one shard includes a plurality of keys, and wherein the (1) data and/or (2) information and/or (3) at least one signal are further based, at least in part, on the following:
at least one determination to update of at least one of the keys of the restored backup.

8. A method of claim 7, wherein the update is based, at least in part, on a determination that the key was modified or added prior to the modification of the routing information.

9. An apparatus comprising:
at least one processor; and
at least one memory including computer program code for one or more programs,
the at least one memory and the computer program code configured to, with the at least one processor, cause the apparatus to perform at least the following,
determine a backup of at least one database or a part of the at least one database associated with a server;
determine to cause, at least in part, actions for resulting in a restoration of the backup to at least one other server; and
determine to cause, at least in part, at least one modification of routing information to route queries for information stored in the at least one database to the at least one other server as part of a rebalancing process.

10. An apparatus of claim 9, wherein the apparatus is further caused to:
determine to compare the restored backup to a current version of the at least one database; and
determine to update the restored backup based, at least in part, on the comparison.

11. An apparatus of claim 10, wherein the update is based, at least in part, on a read-repair process.

12. An apparatus of claim 9, wherein the backup, the restoration, or a combination thereof is performed over a first path and the queries are performed over a second path.

13. An apparatus of claim 9, wherein the rebalancing process includes provisioning the at least one other server, decommissioning the server, or a combination thereof.

14. An apparatus of claim 9, wherein the at least one database includes at least one shard.

15. An apparatus of claim 14, wherein the at least one shard includes a plurality of keys, and wherein the apparatus is further caused to:
determine to update of at least one of the keys of the restored backup.

16. An apparatus of claim 15, wherein the update is based, at least in part, on a determination that the key was modified or added prior to the modification of the routing information.

17. A computer-readable storage medium carrying one or more sequences of one or more instructions which, when executed by one or more processors, cause an apparatus to at least perform the following steps:
determining a backup of at least one database associated with a server;
determining to cause, at least in part, actions resulting in a restoration of the backup to at least one other server; and
determining to modify routing information to route queries for information stored in the at least one database to the at least one other server as part of a rebalancing process.

18. A computer-readable storage medium of claim 17, wherein the apparatus is further caused to perform:
determining to compare the restored backup to a current version of the at least one database; and
determining to update the restored backup based, at least in part, on the comparison.

19. A computer-readable storage medium of claim 18, wherein the update is based, at least in part, on a read-repair process.

20. A computer-readable storage medium of claim 17, wherein the backup, the restoration, or a combination thereof is performed over a first path and the queries are performed over a second path.

21.-43. (canceled)
